(19) United States
(12) Patent Application Publication
(10) Pub. No.: US 2011/0040979 A1
(43) Pub. Date: Feb. 17, 2011

(54) NETWORKED SECURE LOGON SYSTEM

(76) Inventor: Michael Monasterio, Brunswick, OH (US)

Correspondence Address: Michael Monasterio, Suite 371, 3660 Center Road, Brunswick, OH, 44212, US

(21) Appl. No.: 12/857,466

(22) Filed: Aug. 16, 2010

Related U.S. Application Data
(60) Provisional application No. 61/234,240, filed on Aug. 14, 2009.

(51) Int. Cl. G06F 21/00

(52) U.S. Cl. 713/182; 726/19

(57) ABSTRACT

A computer readable medium including encoded computer readable program code configured to be executed to perform a method for controlling access to a computing device is disclosed. The method comprises the steps of accessing a remote data store of secured login credentials; retrieving a set of secured login credentials from the remote data store; unsecuring the set of secured login credentials to create a set of unsecured login credentials on a local computing device; and supplying the set of unsecured login credentials to a login process that is configured to control access to the local computing device. Structures related to execution of the method are also provided.

### PRIORITY CLAIM AND RELATED APPLICATIONS

This application claims priority to and incorporates by reference as if fully rewritten herein U.S. Provisional Patent Application Ser. No. 61/234,240 filed Aug. 14, 2009, titled “NETWORKED SECURE LOGON SYSTEM,” which incorporates by reference U.S. Provisional Patent Application Ser. No. 61/047,421 filed Apr. 23, 2008, titled “SECURE LOGON SYSTEM”. This application additionally claims priority to and incorporates by reference U.S. patent application Ser. No. 12/429,086 filed Apr. 23, 2009, titled “SECURE LOGON SYSTEM”.

### TECHNICAL FIELD

The disclosed systems and methods relate generally to the field of computing systems and more particularly to systems and methods for controlling access to computing systems.

### BRIEF DESCRIPTION OF THE DRAWINGS

FIG. 1 is a flow diagram that depicts steps in a log on procedure.

FIG. 2 is a flow diagram that depicts steps in a log on procedure.

FIG. 3 is a flow diagram that depicts steps in a log on procedure.

FIG. 4 is a flow diagram that depicts steps in a log on procedure.

FIG. 5 is a flow diagram that depicts steps in a remote server process of a log on procedure.

### DETAILED DESCRIPTION

The disclosed subject matter relates to systems and methods to control access to computing systems, specifically including systems and methods to securely automate logon operations. It should be understood that the disclosed systems and methods can be implemented in software, in hardware, or by using a combination of software and hardware. It should also be understood that software can be implemented or stored using any appropriate computer-readable medium such as magnetic or optical tapes or disks, flash memory, or another suitable medium.

It should be noted that the following includes one or more examples of one or more specific implementations and any language that indicates that any specific component or feature is mandatory should be understood to indicate that such component or feature may be mandatory for that specific implementation only and is not necessarily mandatory for understanding, implementing, or operating a similar system.

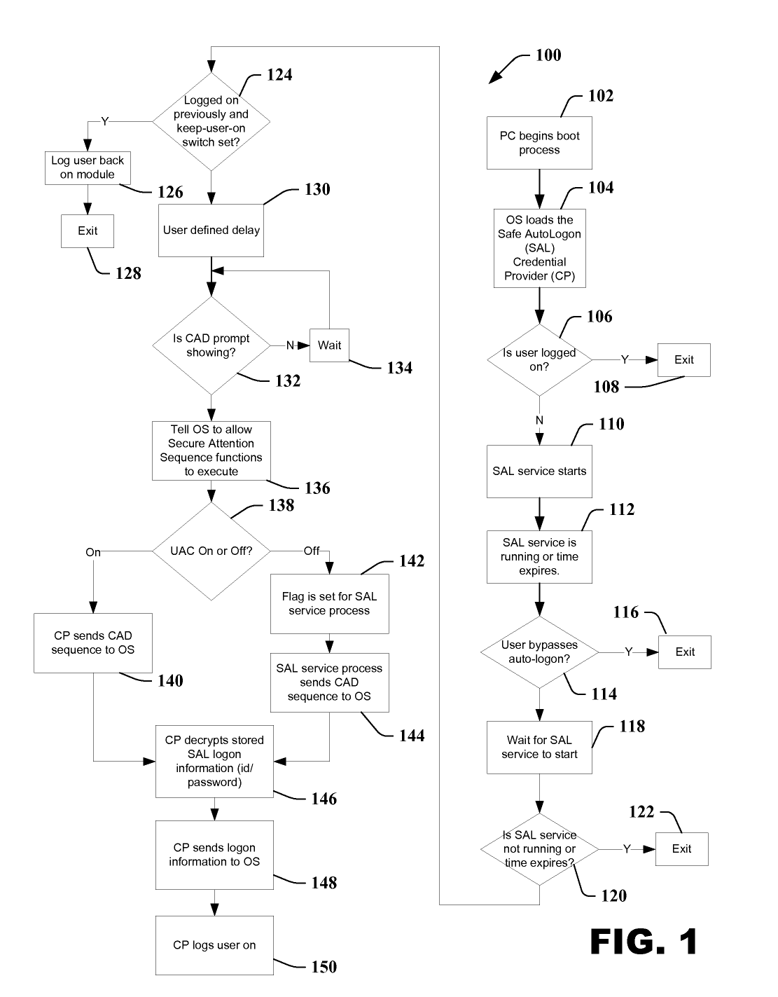

FIG. 1 is a flow diagram that illustrates steps in a method 100 that can be used to securely log into a computing system. Execution of the method 100 begins at process block 102, where a computer (labeled PC), has been powered on and begins its boot up process. The boot process can be initiated from a cold start or from a restart or reboot of the computer. Those of ordinary skill in this art area will recognize that boot process particulars can and typically will vary according to specific hardware, firmware, and software configurations on any particular machine.

Execution of the method 100 continues at process block 104. At process block 104, the computer operating system (labeled OS) loads the Safe AutoLogon (abbreviated as SAL) Credential Provider (labeled CP). The CP can obtain and use logon credentials to enable automated logon operations as well as other functions. Processing continues at decision block 106 where a check is performed to determine whether a user is already logged on. If the determination made at decision block 106 is YES, processing continues at process block 108, where the execution of the method exits. If the determination at decision block 106 is NO, processing continues at process block 110, where SAL service starts.

At process block 112, SAL service runs or time expires. Processing continues at decision block 114. At decision block 114, a determination is made as to whether a user has bypassed an auto-logon process. If the determination made at decision block 114 is YES, processing continues at process block 116, where the execution of the method exits. If the determination at decision block 114 is NO, processing continues at process block 118, where the process waits for the SAL service to start. The process then continues at decision block 120. At decision block 120, a determination is made whether the SAL service is not running or time has expired. If that determination is YES, processing continues at process block 122, where the execution of the method exits.

If the determination at decision block 120 is NO, processing continues at decision block 124, where a determination is made as to logged on previously and keep-user-on switch has been set. If the determination at decision block 124 is YES, processing continues at process block 126, where a log user back on module executes and processing continues at process block 128, where the execution of the method exits. If the determination at decision block 124 is NO, processing continues at process block 130, where a user defined delay can occur.

Processing continues to decision block 132. At decision block 132, a determination is made whether the system's Control-Alt-Delete (labeled CAD) prompt is showing. If the determination is NO, processing continues at process block 134, for a wait and loop back to decision block 132.

If the determination at decision block 132 is YES, processing continues at process block 136, where the SAL service tells the computer operating system (labeled OS) to allow the Secure Attention Sequence functions to execute.

Processing continues at decision block 138. At decision block 138 the system User Access Control is determined to be either On or Off. If the determination at decision block 138 is On, processing continues at process block 140, where the CP sends the Control-Alt-Delete sequence to the operating system. Processing proceeds to process block 146. If the determination at decision block 138 is Off, processing continues at process block 142, where a flag is set for the SAL service process. Processing proceeds to process block 144 where the SAL service sends the Control-Alt-Delete sequence to the operating system.

At process block 146, the CP decrypts stored SAL logon information, which can include an ID, password or both. Processing continues at process block 148, where the CP sends the logon information to the operating system. Execution of the method 100 continues at process block 150, where the CP logs the user on.

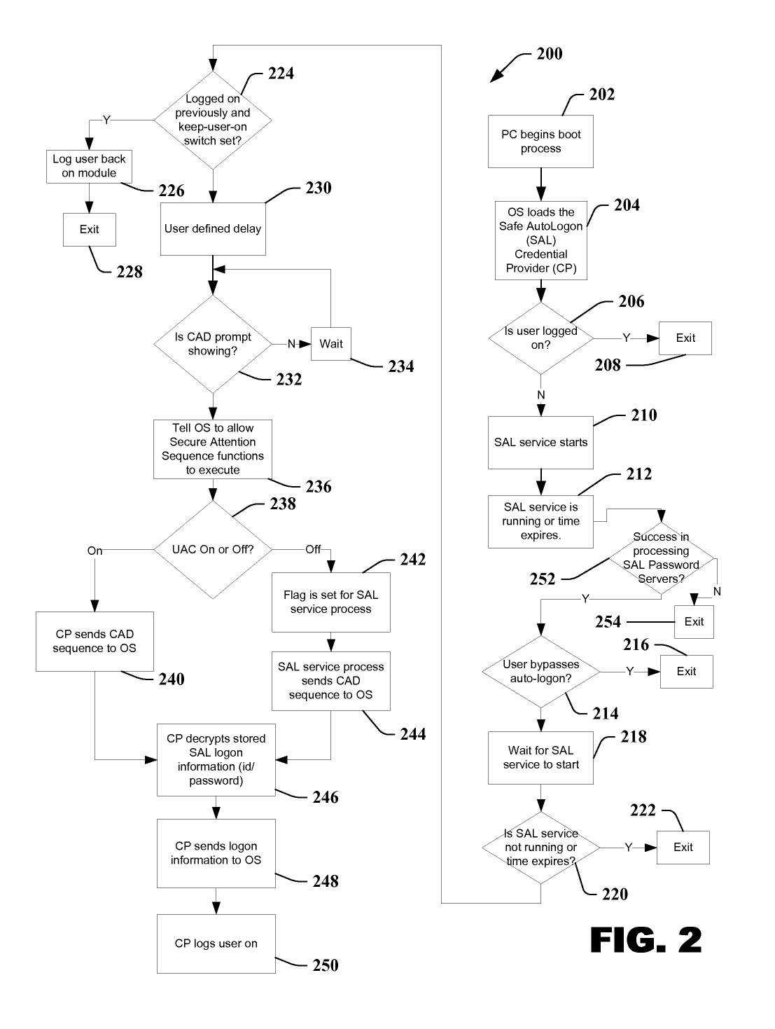

FIG. 2 is a flow diagram that illustrates steps in a method 200 that can be used to securely log into a computing system. Process and decision blocks with like numbers are similar to method 100. Execution of the method 200 begins at process block 202, where a computer (labeled PC), has been powered on and begins its boot up process. The boot process can be initiated from a cold start or from a restart or reboot of the computer. Those of ordinary skill in this art area will recognize that boot process particulars can and typically will vary according to specific hardware, firmware, and software configurations on any particular machine.

Execution of the method 200 continues at process block 204. At process block 204, the computer operating system (labeled OS) loads the Safe AutoLogon (abbreviated as SAL) Credential Provider (labeled CP). The CP can obtain and use logon credentials to enable automated logon operations as well as other functions. Processing continues at decision block 206 where a check is performed to determine whether a user is already logged on. If the determination made at decision block 206 is YES, processing continues at process block 208, where the execution of the method exits. If the determination at decision block 206 is NO, processing continues at process block 210, where SAL service starts.

At process block 212, SAL service runs or time expires. After process block 212, processing continues at decision block 252, where a determination is made as to success in processing SAL Password Servers. If the determination at decision block 252 is NO, processing continues at process block 254, where the execution of the method exits. If the determination at decision block 252 is YES, processing continues at decision block 214.

At decision block 214, a determination is made as to whether a user has bypassed an auto-logon process. If the determination made at decision block 214 is YES, processing continues at process block 216, where the execution of the method exits. If the determination at decision block 214 is NO, processing continues at process block 218, where the process waits for the SAL service to start. The process then continues at decision block 220. At decision block 220, a determination is made whether the SAL service is not running or time has expired. If that determination is YES, processing continues at process block 222, where the execution of the method exits.

If the determination at decision block 220 is NO, processing continues at decision block 224, where a determination is made as to logged on previously and keep-user-on switch has been set. If the determination at decision block 224 is YES, processing continues at process block 226, where a log user back on module executes and processing continues at process block 228, where the execution of the method exits. If the determination at decision block 224 is NO, processing continues at process block 230, where a user defined delay can occur.

Processing continues to decision block 232. At decision block 232, a determination is made whether the system's Control-Alt-Delete (labeled CAD) prompt is showing. If the determination is NO, processing continues at process block 234, for a wait and loop back to decision block 232.

If the determination at decision block 232 is YES, processing continues at process block 236, where the SAL service tells the computer operating system (labeled OS) to allow the Secure Attention Sequence functions to execute.

Processing continues at decision block 238. At decision block 238 the system User Access Control is determined to be either On or Off. If the determination at decision block 238 is On, processing continues at process block 240, where the CP sends the Control-Alt-Delete sequence to the operating system. Processing proceeds to process block 246. If the determination at decision block 238 is Off, processing continues at process block 242, where a flag is set for the SAL service process. Processing proceeds to process block 244 where the SAL service sends the Control-Alt-Delete sequence to the operating system.

At process block 246, the CP decrypts stored SAL logon information, which can include an ID, password or both. Processing continues at process block 248, where the CP sends the logon information to the operating system. Execution of the method 200 continues at process block 250, where the CP logs the user on.

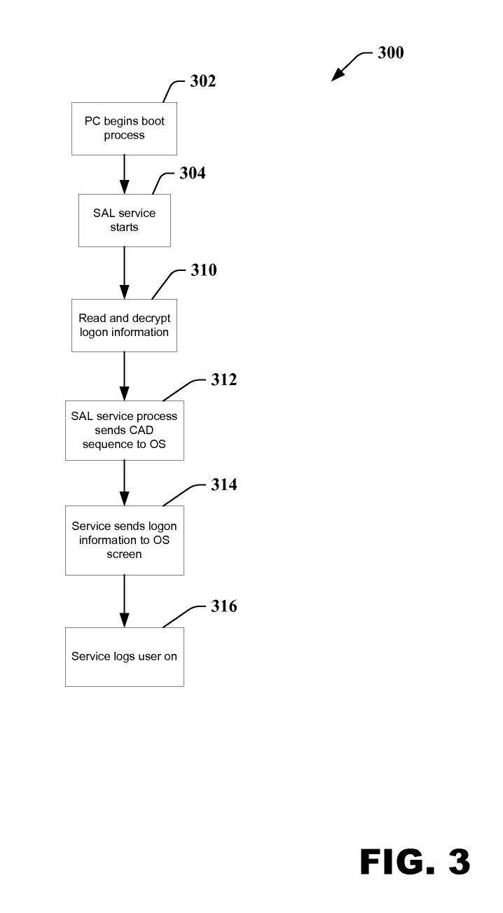

FIG. 3 is a flow diagram that illustrates steps in a method 300 that can be used to securely log into a computing system. Execution of the method 300 begins at process block 302, where a computer (labeled PC), begins its boot up process. The boot process can be initiated from a cold start or from a restart or a reboot of the computer. Those of ordinary skill in this art area will recognize that boot process particulars can and typically will vary according to specific hardware, firmware, and software configurations on any particular machine.

Execution of the method 300 continues at process block 304. At process block 304, the Safe AutoLogon (abbreviated as SAL) service starts. The process continues at process block 310, where logon information is read and decrypted.

Processing continues at process block 312, where the SAL service sends the Control-Alt-Delete sequence to the operating system. Processing continues at process block 314, where the service sends the logon information to the operating system screen. At process block 316, the service logs the user on.

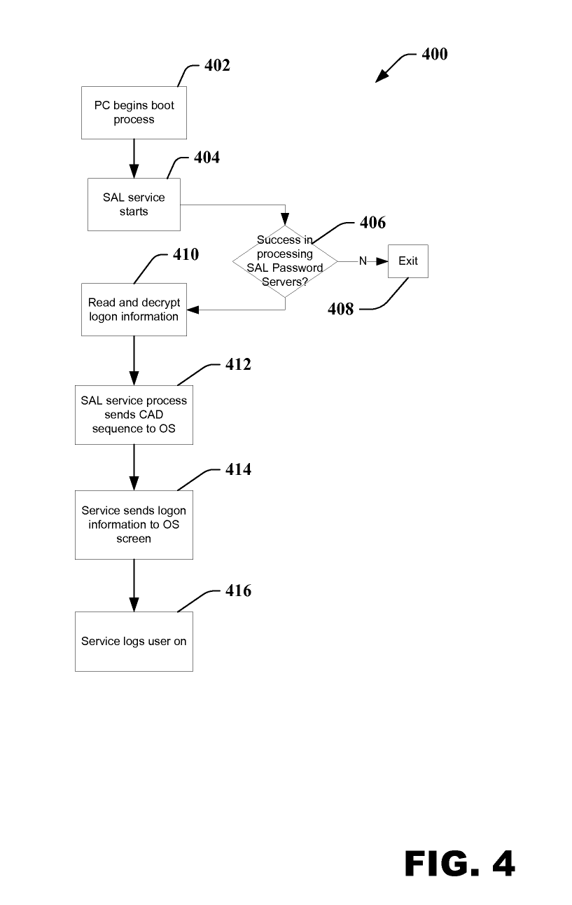

FIG. 4 is a flow diagram that illustrates steps in a method 400 that can be used to securely log into a computing system. Process and decision blocks with like numbers are similar to method 300. Execution of the method 400 begins at process block 402, where a computer (labeled PC), begins its boot up process. The boot process can be initiated from a cold start or from a restart or a reboot of the computer. Those of ordinary skill in this art area will recognize that boot process particulars can and typically will vary according to specific hardware, firmware, and software configurations on any particular machine.

Execution of the method 400 continues at process block 404. At process block 404, the Safe AutoLogon (abbreviated as SAL) service starts. Processing continues at decision block 406, where a determination is made as to success in processing SAL Password Servers.

If the determination at decision block 406 is NO, processing continues at process block 408, where the execution of the method exits.

If the determination at decision block 406 is YES, processing continues at process block 410 where logon information is read and decrypted.

Processing continues at process block 412, where the SAL service sends the Control-Alt-Delete sequence to the operating system. Processing continues at process block 414, where the service sends the logon information to the operating system screen. At process block 416, the service logs the user on.

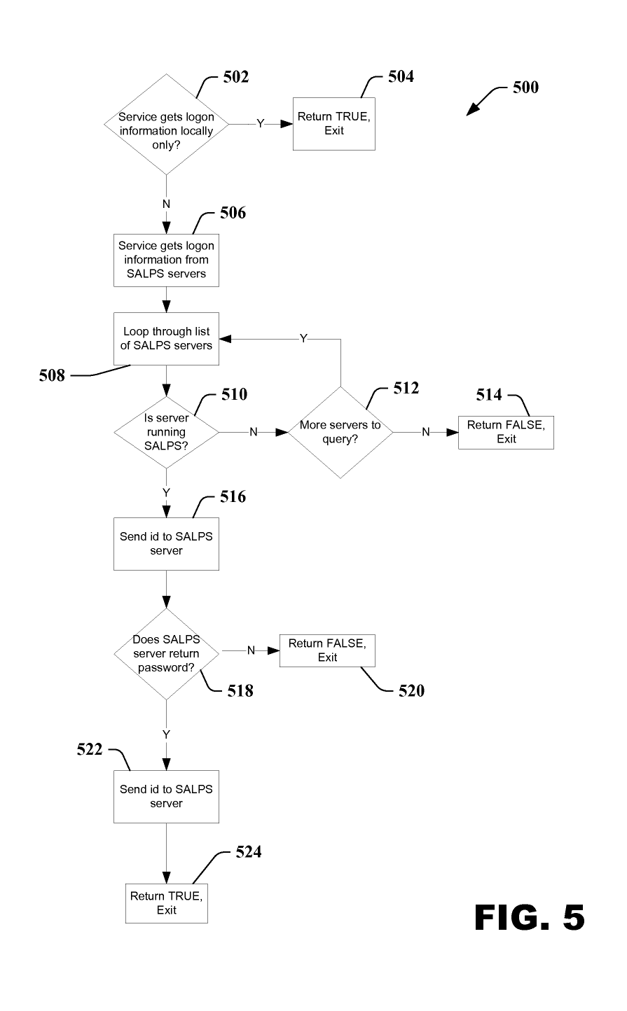

FIG. 5 is a flow diagram that illustrates steps in a method 500 that can be used to securely log into a computing system that includes the use of remote servers. Method 500 starts at decision block 502, where a determination is made as to whether the service gets logon information locally only. If the determination is YES, the process continues at process block 504, where a value of TRUE is returned and the process exits. If the determination at decision block 502 is NO, the process continues at process block 506. At process block 506, the service obtains logon information from SALPS servers. Processing continues at process block 508, where a loop through list of SALPS servers is executed. The process continues at decision block 510, where a determination is made if the server is running SALPS. If the determination is NO, the process moves to decision block 512, where a determination of more servers to query is made. If the determination at decision block 512 is YES, the process loops to process block 508. If the determination at decision block 512 is NO, the process moves to process block 514, where a value of FALSE is returned and the process exits.

If the determination at decision block 510 is YES, the process continues at process block 516, where ID is sent to SALPS server. Processing continues at decision block 518. A determination is made at decision block 518 if the SALPS server returns password. If the determination at decision block 518 is NO, processing continues at process block 520, where a value of FALSE is returned and the process exits. If the determination at decision block 518 is YES, the process continues at process block 522, where the ID is sent to SALPS server. The process continues at process block 524, where a value of TRUE is returned and the process exits.

What has been described above includes examples. It is, of course, not possible to describe every conceivable combination of components or methodologies for purposes of describing the disclosed systems and methods, but one of ordinary skill in the art may recognize that many further combinations and permutations within the scope of the innovations herein disclosed are possible. Accordingly, the disclosed systems and methods are intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated embodiments. In this regard, it will also be recognized that the disclosed systems and methods include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer readable medium including encoded computer readable program code configured to be executed to perform a method for controlling access to a computing device comprising the steps of:
accessing a remote data store of secured login credentials;
retrieving a set of secured login credentials from the remote data store;
unsecuring the set of secured login credentials to create a set of unsecured login credentials on a local computing device; and
supplying the set of unsecured login credentials to a login process that is configured to control access to the local computing device.

2. The computer readable medium of claim 1, wherein the secured login credentials are secured by encrypting the secured login credentials to create encrypted login credentials.
